(19) United States
(12) Patent Application Publication
(10) Pub. No.: US 2003/0102211 A1
(43) Pub. Date: Jun. 5, 2003

(54) Electrolyzer

(76) Inventors: Shinichi Nakamura, Osaka (JP); Kunihiko Fukuzuka, Osaka (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/270,694

(22) Filed: Oct. 16, 2002

(30) Foreign Application Priority Data
Dec. 4, 2001 (JP) 2001-369794

(51) Int. Cl. C02F 1/461

(52) U.S. Cl. 204/276; 205/742; 205/751; 205/758

(57) ABSTRACT

At least one of an anode and a cathode or at least a cathode has holes or pores for filtration. To remove floating material, soil suspending materials and/or hydroxides such as Calcium formed on the filterable electrode(s), at intervals between the electrolysis processes, the direction of water flow is reversed, and treated water is pulled back through the electrode(s) and electrolyzed again, whereby the materials deposited on electrode(s) is removed.

### BACKGROUND OF THE INVENTION

1. Technical Field of the Invention

The present invention relates to a method of electrolysis and an electrolytic apparatus in which floating materials, suspended materials in water or waste water such as swimming pool water, domestic wastewater, collected secondary water, ponds, lagoons (in theme parks, etc.), industrial wastewater, cooling tower/air conditioning water, water in fish breeding tanks, seawater for washing fishery products, agricultural and fishery processing water, washing water for food product plants and discharged and washing water from landfills for industrial waste are removed.

2. Description of Related Art

In a conventional method or apparatus for purifying or sterilizing water or waste water, the electrolytic apparatus has been used for purification and sterilization of such water. However, suspended particles such as floating materials cannot be removed.

### SUMMARY OF THE PRESENT INVENTION

It is an object of the present invention to remove suspended materials or floating materials in water such as wastewater soil or suspending water before electrolyzing.

It is another object of the present invention to purify and sterilize water or wastewater containing water-soluble dirt or microorganisms by effectively electrolyzing it.

It is a further object of the present invention to remove or dissolve materials such as calcium or hydroxide of magnesium deposited, through the removal of suspended material and floating material, on the electrode(s) or filters etc.

It is still further object of the present invention to remove materials at interval between electrolysis processes.

According to the present invention, electrode(s) (at least one of an anode and a cathode, for example, at least a cathode) has holes or pores to remove suspended materials or floating materials in water and then the water is electrolyzed. Further, to remove floating material, soil suspending materials and/or hydroxides such as Calcium formed on the filterable electrode(s), at intervals between the electrolysis processes, the direction of water flow is reversed, and treated water is pulled back via the electrode(s) and electrolyzed again, whereby the materials deposited on electrode(s) is removed.

### BRIEF DESCRIPTION OF THE DRAWINGS

The present inventions will now be described by way of example with reference to the following figures in which:

FIG. 1A is a block diagram showing an electrolyzer system according to the present invention;

FIG. 1B is a sectional view of the electrolyzer taken along the 1B-1B line shown in FIG. 1;

FIG. 2A is a sectional view of an electrolyzer in a second embodiment showing a normal electrolysis process;

FIG. 2B is a sectional view thereof showing a back-wash process;

FIG. 3A is a block diagram of an electrolyzer system in a third embodiment according to the present invention;

FIG. 3B is a sectional view thereof taken along the 3B-3B line shown in FIG. 5;

FIG. 4 is an exploded view of an electrolyzer in a forth embodiment according to the present invention; and

FIG. 5 is a sectional view of an electrolyzer a third embodiment thereof.

### DETAILED DESCRIPTION OF THE PREFERRED EMBODIMENTS

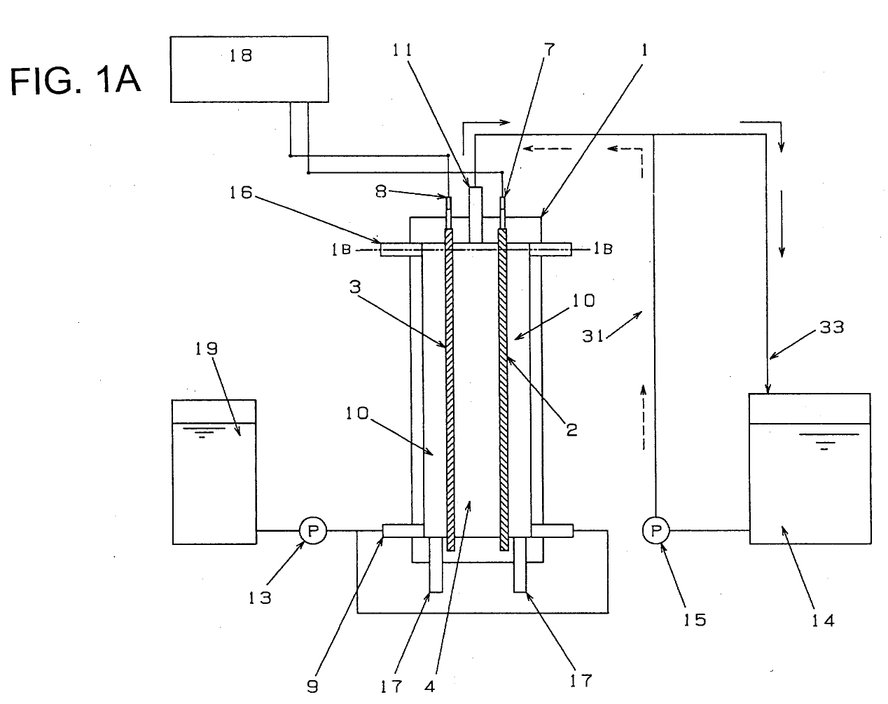

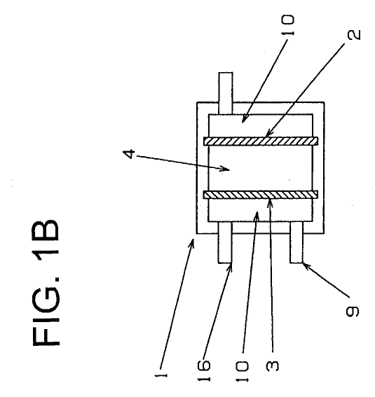

FIG. 1A is a block diagram showing an electrolyzer system according to the present invention. FIG. 1B is a sectional view of the electrolyzer taken along the 1B-1B line shown in FIG. 1A.

An electrolyzer (electrolytic apparatus) 1 comprises supplying paths 10, an inlet 9 for introducing water to be treated into the supplying paths 10, electrodes (an anode 2 and cathode 3), an electrolytic path 4 (a reaction area between the electrodes), the supplying (discharge) paths 10 and an outlet 11 for discharging electrolyzed water. Both of the electrodes or at least one of the anode 2 and the cathode 3 (such as at least the cathode 3) is a filterable porous electrode. The anode 2 and cathode 3 are connected to a controller/power supply device 18 through an anode terminal 7 and a cathode terminal 8 respectively. The controller 18 controls electrolysis processes.

The water to be treated is filtered through the filterable porous electrode 3 and guided along the electrolytic path 4 between the anode 2 and cathode 3 and electrolyzed. The electrodes can be a plate or tube.

In a normal electrolysis process, water stored in water tank 19 is supplied to the supplying path 10 by a transfer pump 13 via the inlet 9, and then is filtered through the porous filterable electrodes, such as the cathode 3 and/or anode 2 in FIG. 1, and then electrolyzed in the electrolytic path 4 between the cathode 3 and the anode 2. The electrolyzed water is discharged from the outlet 11 and transferred via a normal electrolysis process line 33 and stored in an electrolyzed water bath 14.

Next, a back-wash process for removing suspended particles such as floating materials, calcium or hydroxide of magnesium, deposited on filterable porous electrode(s), will be described.

The water to be treated is redrawn through a back-wash process line 31 from the electrolyzed water bath 14, etc., by reversing the direction of the flow by a backwash pump 15 at designated time intervals between the normal electrolysis processes for purifying and sterilizing the water to be treated.

Thus, the once electrolyzed water is electrolyzed again in the electrolysis path 4, and then both filterable porous electrodes or at least the filterable porous cathode are washed with the reversed flow of the twice electrolyzed water, and then the twice-electrolyzed water is discharged from a back-wash outlet 16. After the back washing operation is completed, the remaining materials such as suspended particles, solid floating materials and deposits are discharged with the remaining liquid by opening drain outlets 17 for the electrolytic path 4 (a reaction area between the electrodes) and supply path 10 provided at the bottom of the electrolytic path 4 and the supply path 10 respectively.

The filterable porous electrodes may comprise filters, such as conductive wire gauze, a metal plate with minute round holes or openings such as slits, filterable carbon with minute slits, filterable conductive ceramic, or a conductive plastic filter.

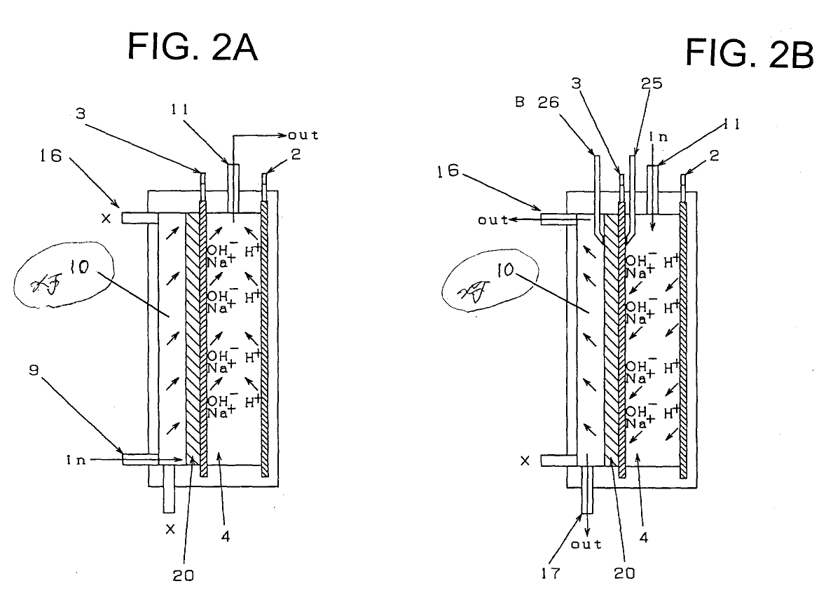

FIGS. 2A and 2B show a sectional view of an electrolyzer 1 in a second embodiment according to the present invention.

In this embodiment, a filterable porous electrode (cathode 3) and a filter 20 are integrated. The filter 20 is attached to the surface opposite to the electrolysis surface of the porous electrode, which has a number of pores. As shown in FIG. 2A, water to be treated is supplied from a water source (not shown) through an inlet 9 to a supplying path 10 and then filtered by the filter 20 and the cathode 3 with a number of pores. The filtered water is electrolyzed in an electrolytic path 4 and then discharged from an outlet 11. The electrolyzed water is stored in a tank not shown.

As shown in FIG. 2B, in a back-wash process, the once electrolyzed water is supplied from the tank into the electrolytic path 4 through the outlet 11 and electrolyzed again.

The twice-electrolyzed water passes through the cathode 3 and the filter 20 and discharged from a back-wash outlet 16. In the normal electrolysis process, the back-wash outlet 16 is closed. In the back-wash process, the inlet 9 is closed. In this embodiment, sampling pipes 25 and 26 are provided on the surface of the cathode 3 and the filter 20 respectively.

After the back-washing process is completed, the remaining materials such as suspended particles, solid floating materials and deposits are discharged with the remaining liquid by opening the drain outlets 17 for the electrolytic path 4 (a reaction area between the electrodes) and a supplying path 10 provided at the bottom of the electrolytic path 4 and the supplying path 10 respectively.

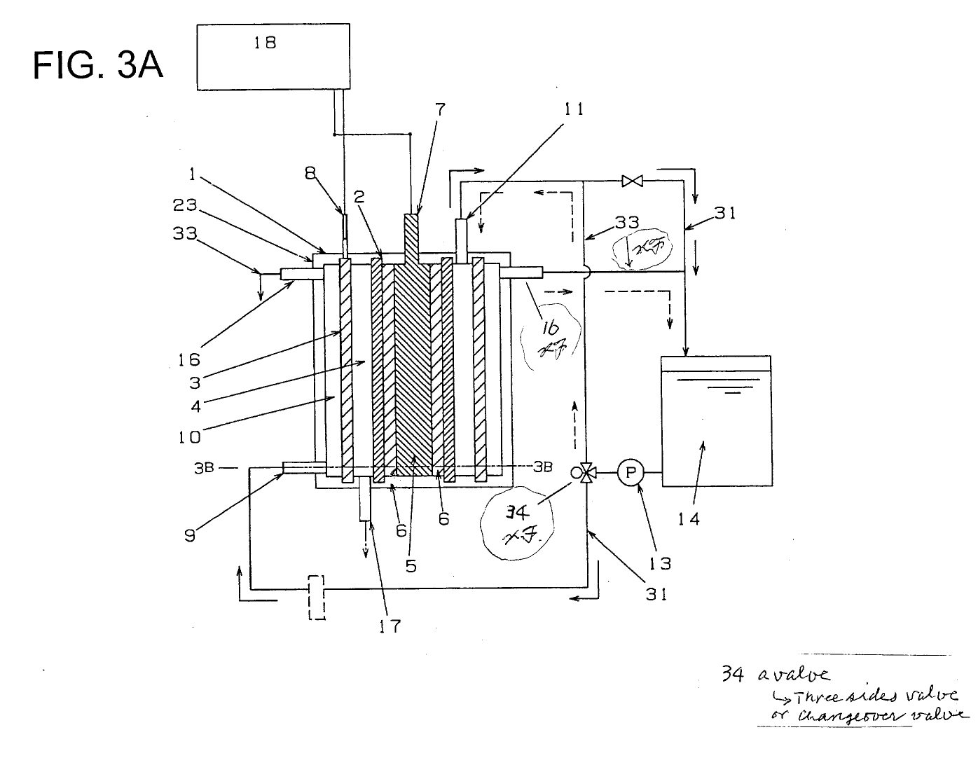

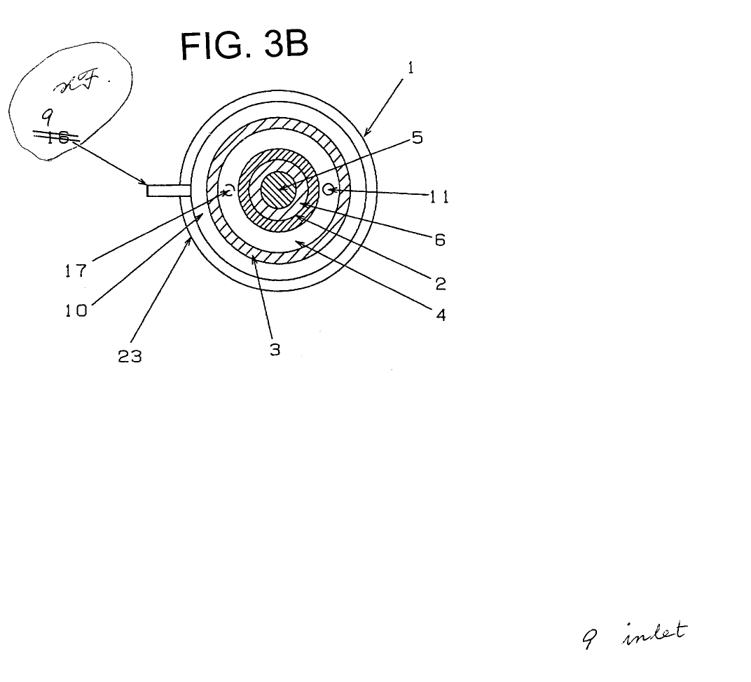

Referring to FIGS. 3A and 3B, the third embodiment will be described.

FIG. 3A shows a block diagram of an electrolyzer system in a third embodiment according to the present invention. In the electrolyzer system 1, electrolysis and back-wash processes are carried out as in the previous embodiments.

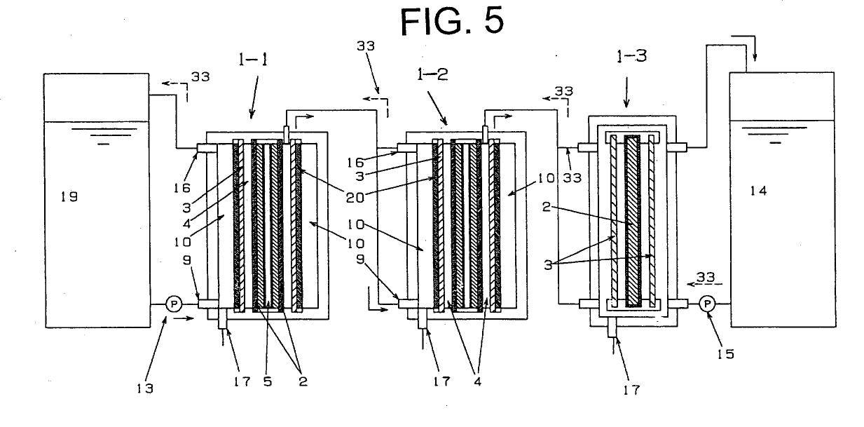

FIG. 3B is a sectional view of the electrolyzer 1 taken along the 3B-3B line shown in FIG. 5.

In this embodiment, an anode 2, a cathode 3 and an electrolysis case 23 are cylindrical. An anode terminal 5 is also cylindrical and inserted in the cylindrical anode 2. In a gap between the anode 2 and the anode terminal 5, mercury or low melting point metal is filled up in a low melting point metal connecting portion (mercury filling portion) 6. The anode 2 and the cylindrical cathode 3 having a plurality of pores form an electrolysis path 4 therebetween.

Further, back-wash outlets 16 are connected to electrolytic bath 14. Thus, the once-electrolyzed water is supplied back into the electrolytic bath 14. Water drawn from the electrolytic bath 14 through a pump 13 is changed in a direction by a valve 34. In this embodiment, water to be treated is supplied from an electrolytic tank 14 to supplying path 10 and electrolyzed after the water passes through the filterable electrode 3 to the electrolytic path 4. The treated (electrolyzed) water is supplied back to the electrolytic tank 14. In a back wash operation, the once electrolyzed water in the electrolytic path 4 is supplied to the electrolytic path 4 via valve 34, a back wash line 33 and inlet 11. In the electrolytic path 4, the supplied water is electrolyzed.

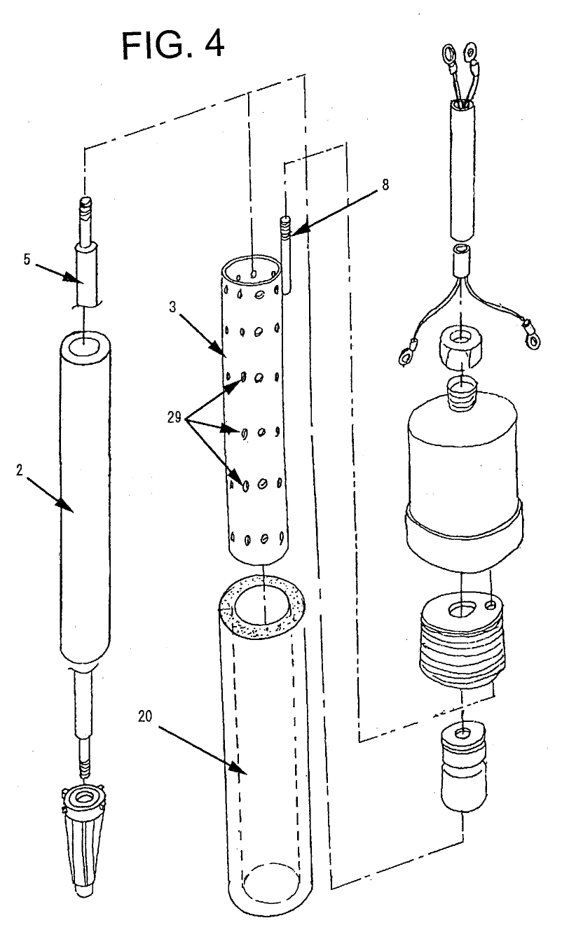

FIG. 4 is an assembly diagram of a soaking type of an electrolysis device 21 in a forth embodiment according to the present invention.

The electrolysis device 21 does not have an electrolysis case. It looks like an electrolyzer in which an electrolysis case 23 is removed. The electrolysis device 21 is directly immersed in an electrolytic treatment vessel not shown and electrolyzes water in the vessel, whereby air rift action of gas created by electrolysis is generated. Further, the air rift action creates convection and circulation action of water in the electrolytic path 4 (a reaction area between the electrodes). The water is filtered by the convection and circulation action of the water.

FIG. 5 is a sectional view of a electrolytic system according to a fifth embodiment in the present invention.

A plurality of electrolyzers are connected in series between a water tank 19 and an electrolytic bath 14. Water to be treated is supplied from the water tank 19 by a transfer pump 13 to a first electrolyzer 1-1, and electrolyzed. The electrolyzed water is discharged from the first electrolyzer 1-1 and supplied to a second electrolyzer 1-2, and electrolyzed. The twice electrolyzed water is discharged from the second electrolyzer 1-2 and supplied to the third electrolyzer 1-3, and electrolyzed, and then the three times electrolyzed water is discharged into the electrolytic bath 14.

In a back-wash process, the three times electrolyzed water in the electrolytic bath 14 is supplied to the third electrolyzer 1-3 by a pump 15. As such, the water is electrolyzed in the second electrolyzer 1-2 and the first electrolyzer 1-1 and then finally discharged into the water tank 19.

In the above-mentioned embodiments, the water to be electrolyzed can be introduced from the supplying paths 10 corresponding the anode 2 and the cathode 3 respectively to the electrolytic path 4. However, the water to be electrolyzed may be introduced directly to the electrolytic path 4, and discharged from the supplying path 4 (in this case, the discharging path 4) after it is electrolyzed and passed through the pores of the anode 2 and cathode 3, whether the electrodes are a plate or tube.

In the above-mentioned embodiments, by using a porous conductive material with a pore diameter of 0.1 μm to 8 mm as the filterable porous electrode, the electrodes serve as a filter. Additionally the effective surface area of the electrolytic surface of the electrode becomes larger than that of a metal plate having a smooth surface that is normally used as an electrode. In case that the diameter of the suspended matters and floating materials are large, such as ones from the discharge or washing water for a landfill for industrial waste, it is appropriate to have a pore diameter of 300 μm to 8 mm. It is desirable to set the filtering performance by selecting a pore diameter based on the state of the wastewater, etc., and the quality of the desired treated water.

Next, a back wash operation at designated time intervals will be described.

In case that the wastewater, etc., is electrolyzed for a long period of time, the back-wash process is effective. That is, in order to remove suspended and floating particles in the water to be treated or materials such as calcium or hydroxide of magnesium deposited on or attached to the porous electrode such as the cathode 3, the water to be treated is redrawn from the electrolytic bath 14, etc., by reversing the direction of flow at designated time intervals between the normal electrolysis processes that are to purify and sterilize the water to be treated, and thus it is electrolyzed again along the electrolysis path 4, and the porous electrodes are back-washed with the electrolyzed water.

Further, in the above-mentioned embodiments, when both the anode and the cathode have pores, the electrolyzer uses a reversed flow unlike the regular purification/sterilization process, and therefore the electrolyzed water generated along the electrolysis path 4 flows in reverse from inside to outside through all the gaps in the porous electrodes, and the strong acidic water generated at the anode 2 not only flows outside through the gaps of the anode 2 but also flows toward the cathode 3, and is discharged outside through the pores of the cathode 3 while being neutralized by the alkali generated by the cathode. The alkali generated by the cathode 3 also flows outside, and thus the surface of the cathode 3 along the electrolysis path 4 becomes acidic, and calcium or hydroxide of magnesium, etc., deposited on the cathode 3 is either dissolved or peeled off.

When reducing the number of pores on the filterable porous electrodes, or reducing the diameter of the pores, to make the opening space of the anode smaller than the opening space of the filterable porous cathode, it is possible to increase the flow of the electrolyzed water that flows through the cathode more than that for the anode.

An abundance of strong acidic electrolyzed water with a high oxidation ability that is generated at the anode is directed to the filterable cathode. Furthermore, by making only the cathode have many pores or be filterable, then, all of the strong acidic electrolyzed water with a high oxidation ability generated at the anode 2 flows towards the cathode 3 and flows outside by going through all the gaps of the porous cathode 3 and pushes out the alkali ion water, and consequently, floating material, suspending particles deposited at the cathode 3 in the water to be treated, calcium or hydroxide of magnesium, etc., deposited on the cathode 3 can be removed. The organic matter, etc., of suspended particles and floating material in the water to be treated that is attached to the porous electrode(s) (at least one of the anode and cathode) can be oxidatively degraded and removed. This strong acidic water is neutralized by the alkali water generated at the cathode 3 while it goes through the filter of the cathode 3, and becomes slightly acidic with a PH of approximately 3 to 5. Therefore it generates a large quantity of hypohalous acid or active oxygen, and consequently, it reinforces the back-wash of the porous electrode 3 or the filter integrated with the electrode 3

The disclosure of Japanese Patent Application No. 2001-369794 filed on Dec. 4, 2001 including specification, drawings and claims is incorporated herein by reference in its entirety.

Although only some exemplary embodiments of this invention have been described in detail above, those skilled in the art will readily appreciated that many modifications are possible in the exemplary embodiments without materially departing from the novel teachings and advantages of this invention. Accordingly, all such modifications are intended to be included within the scope of this invention.

What is claimed is:

1. An electrolyzer for electrolyzing water, comprising:
an electrolysis case;
an anode provided in the electrolysis case; and
a cathode provided in the electrolysis case;
wherein at least one of the anode and the cathode is filterable, and
wherein the anode and the cathode defines an electrolytic path therebetween, in which water to be treated is electrolyzed after the water is filtered by the at least one of the anode and the cathode.

2. The electrolyzer according to claim 1, wherein at least the cathode is filterable.

3. The electrolyzer according to claim 1, wherein the at least one of the anode and the cathode is made of a filterable material such as conductive wire gauze, a metal plate with opening such as minute holes or slits, a filterable carbon with minute slits, filterable conductive ceramic, or a conductive plastic fiber.

4. The electrolyzer according to claim 1, wherein the anode and the cathode have pores and pore's area of the anode is smaller than that of the cathode.

5. The electrolyzer according to claim 4, wherein a number of the pores of the anode is smaller than those of the cathode.

6. The electrolyzer according to claim 4, wherein a diameter of the plurality of pores is 0.1 μm to 8 mm.

7. The electrolyzer according to claim 2, wherein a filter member is provided on a surface of the cathode.

8. The electrolyzer according to claim 1, further including:
an inlet and an outlet wherein the water to be treated is supplied via the inlet and the electrolyzed water is discharged from the outlet.

9. The electrolyzer according to claim 1, wherein a plurality of electrolyzers are in series connected to the electrolyzer.

10. An electrolyzer for electrolyzing water comprising:
an electrolysis case;
an anode provided in the electrolysis case; and
a cathode provided in the electrolysis case,
wherein at least one of the anode and the cathode is filterable, and the anode and the cathode define an electrolytic path therebetween, in which water is electrolyzed, and
wherein in a normal operation, water is electrolyzed in the electrolytic path after the water is filtered by the at least one of the anode and the cathode, and then the electrolyzed water is discharged from the electrolytic path, and in a back-wash operation, the electrolyzed water is supplied in the electrolytic path and passes the at least one f the anode and the cathode.

11. The electrolyzer according to claim 10, wherein the at least one of the anode and the cathode is made of a filterable material such as conductive wire gauze, a metal plate with opening such as minute holes or slits, a filterable carbon with minute slits, filterable conductive ceramic, or a conductive plastic fiber.

12. The electrolyzer according to claim 10, wherein the electrolyzed water is re-electrolyzed after the electrolyzed water is supplied in the electrolytic path and before passing through the at least one of the anode and the cathode.

13. The electrolyzer according to claim 10, wherein after the back-wash operation, the electrolyzed water is discharged from a back-wash outlet.

14. The Electrolyzer according to claim 13, wherein after the electrolyzed water is discharge, remaining water is discharged via at least one drain outlet.

15. The electrolyzer according to claim 10 wherein a plurality of electrolyzers are in series connected to the electrolyzer.

16. A electrolytic device which is immersed in a water to be treated and electrolyzes the water, the electrolytic device comprising:
an anode having a plurality of pores and an anode terminal;
a filterable cathode having a cathode terminal provided in the anode; and
a protecting case holding the anode terminal and the cathode terminal.

17. The electrolytic device according to claim 16, further including a filter member covering the cathode.

18. The electrolytic device according to claim 16, wherein the at least one of the anode and the cathode is made of a filterable material such as conductive wire gauze, a metal plate with opening such as minute holes or slits, a filterable carbon with minute slits, filterable conductive ceramic, or a conductive plastic fiber.

19. A method of removing materials contained in water, the method comprising:
introducing the water in a supply path;
letting the water through a filterable electrode; and
electrolyzing the water.

20. The method according to claim 19, wherein the step of letting the water through a filterable electrode is repeated more than once.

21. A method of removing materials attached on a filterable electrode of an electrolyzer, comprising:
reversing a direction of water flow in a normal operation; and
letting the water through the filterable electrode.

22. The method of removing materials according to claim 21, further including electrolyzing the water after letting the water through the filterable electrode.

23. The method of removing materials according to claim 21 wherein the step of electrolyzing the water is repeated.

24. The method of removing materials according to claim 21, wherein the step of reversing a direction of water flow is carried out at intervals between electrolysis processes in a normal operation.

25. An electrode for electrolyzing water comprising:
a body of the electrode; and
a terminal attached on the body of the electrode;
wherein the body has a plurality of pores thereon.

26. The electrode according to claim 25, further including a filter covering on the body of the electrode.
